(19) United States
(12) Patent Application Publication
(10) Pub. No.: US 2009/0144169 A1
(43) Pub. Date: Jun. 4, 2009

(54) METHOD FOR FACILITATING ONLINE SALES AND PRODUCT FOR USE THEREFOR

(76) Inventors: DOUG BAKER, WEST HILLS, CA (US); JOSH SHAW, LOS ANGELES, CA (US)

Correspondence Address: ELIZABETH SWANSON;c/o SWANSON & ASSOCIATES, 9454 WILSHIRE BLVD., SUITE 500, BEVERLY HILLS, CA, 90212, US

(21) Appl. No.: 12/257,349

(22) Filed: Oct. 23, 2008

Related U.S. Application Data
(60) Provisional application No. 60/982,063, filed on Oct. 23, 2007.

(51) Int. Cl. G06Q 30/00; G06Q 10/00; G06Q 90/00

(52) U.S. Cl. 705/26; 705/1

(57) ABSTRACT

The method of the disclosure provides creating a unique product from data shared between an artist and a client, which artwork is applied to a product and manufactured only in quantities ordered by members of a discrete group. The members of the group have a common mailing address for the product, and the artwork is prepared by a group chair or contact working with the product manufacturer, not individual group members ordering the product. Financial information is screened from the group chair, but the chair may edit the quantities of product ordered. The identities of all group members are screened from the enterprise manufacturing the product ordered.

### PRIORITY CLAIM

This application claims the benefit of U.S. Provisional Application No. 60/982,063 filed Oct. 23, 2007.

### FIELD OF THE INVENTION

This invention relates to electronic commerce and information processing. More specifically, this invention relates to information processing methods for assisting group members in creating a unique product for a social event in coordination with an enterprise which then manufactures and ships the created product to a group of members at a single geographical address. This invention also relates to a method of selectively disclosing and sharing private address and financial data of group members to protect the secrecy and privacy concerns of those members.

### BACKGROUND OF THE INVENTION

The method disclosed grew out of an online business method for designing, producing and supplying unique, event-related T-shirts to sorority members easily. The method employed creation of the T-shirts and a limited access webpage from a design concept provided by a sorority event chair, and then making the T-shirts available to sorority members for ordering online through their own event-related webpage. The method enabled a sorority and fraternity to provide T-shirts to its members without burdening the event chair with the responsibility of collecting money and orders from individual members. It also provided a certain cachet to an event by providing a unique and exclusive webpage that other sororities did not have.

### SUMMARY OF THE INVENTION

Disclosed herein are significant improvements to the original business, applicable to creating and ordering product for any group, which improvements comprise at least the following: Creating a computerized project record at the beginning of a project; creating a computerized client record; collecting product and artwork input and feedback via the internet; creation of a unique project website for selling product to members of a group once artwork has been approved; creating virtual images of the artwork superimposed onto images of template projects on a website as examples of finished products; fulfilling product orders for the members; providing limited member information to the enterprise fulfilling the project order; providing limited member financial information to a supervising member or group representative; and providing the ability to manipulate the project information by a group representative who is overseeing or monitoring group member purchasing activity.

### ILLUSTRATIONS

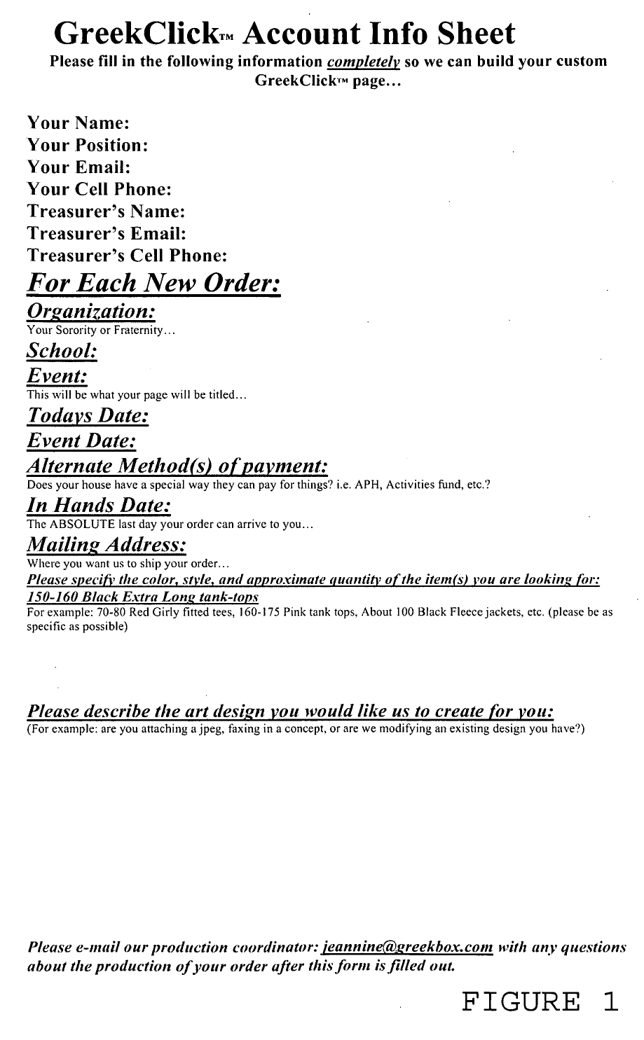

FIG. 1 comprises an account information sheet in a word processing format;

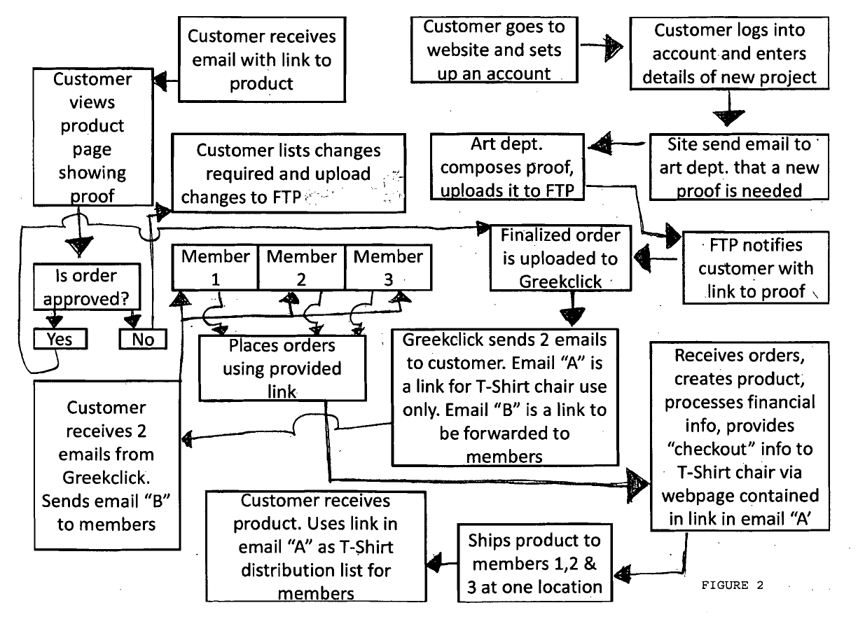

FIG. 2 comprises a flowchart showing the flow of information according to an embodiment of the disclosure;

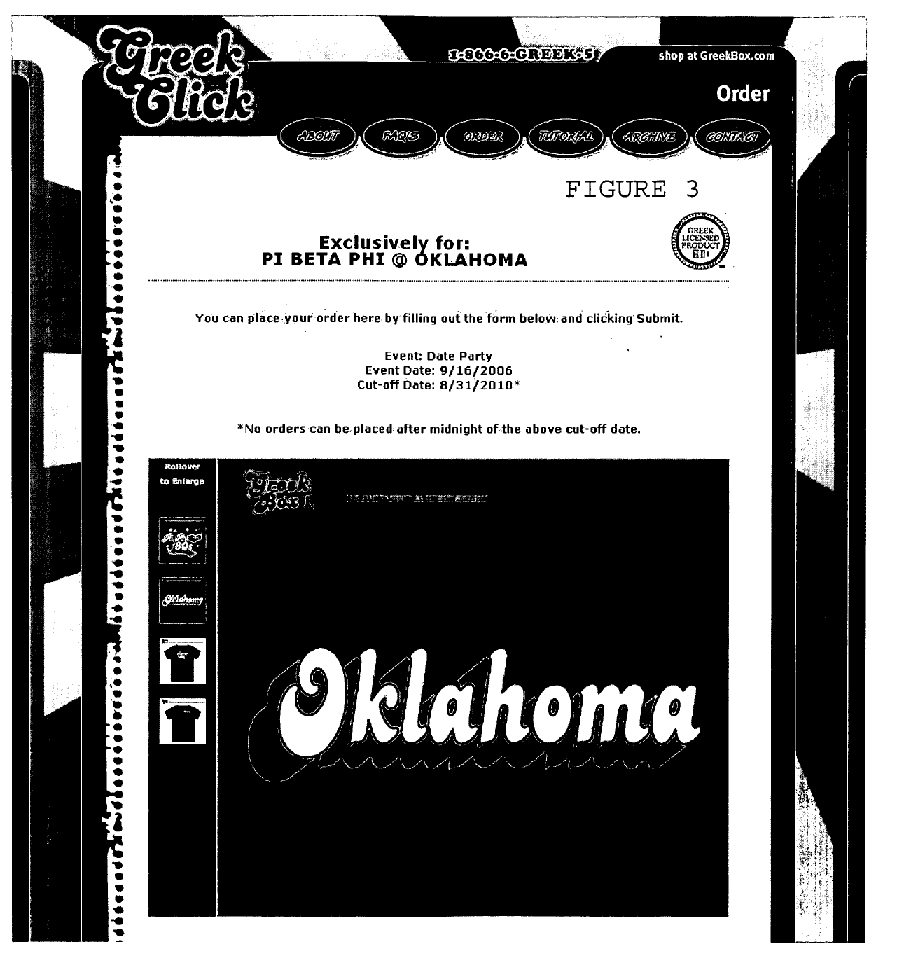

FIG. 3 comprises a screenshot of the first part of a project webpage generated by one embodiment of the disclosure;

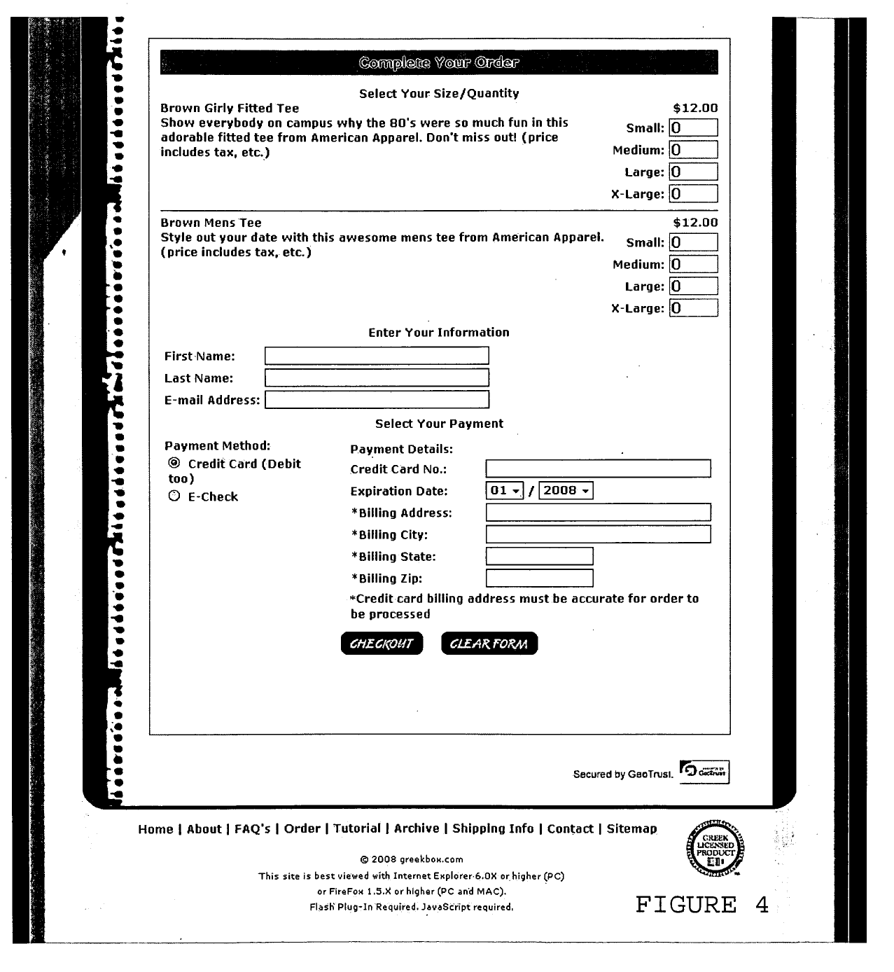

FIG. 4 comprises a screenshot of the second part of a project webpage comprising ordering fields generated by one embodiment of the disclosure;

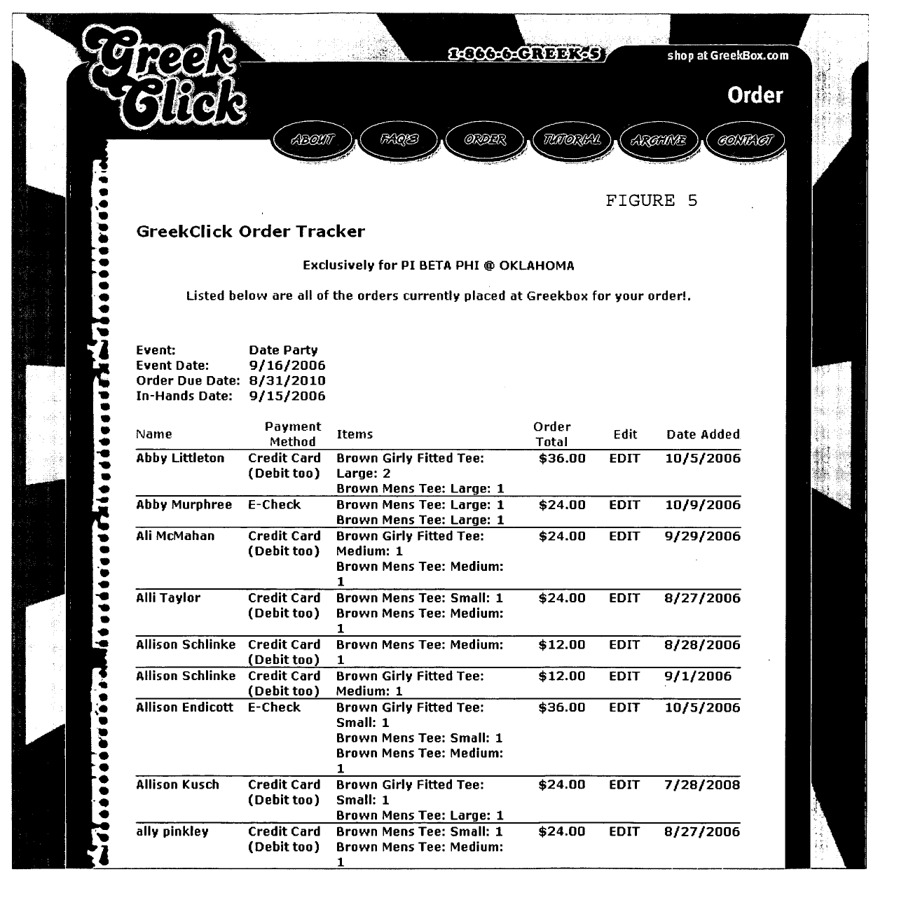

FIG. 5 comprises a screenshot of the first part of an order tracker report generated by one embodiment of the disclosure; and

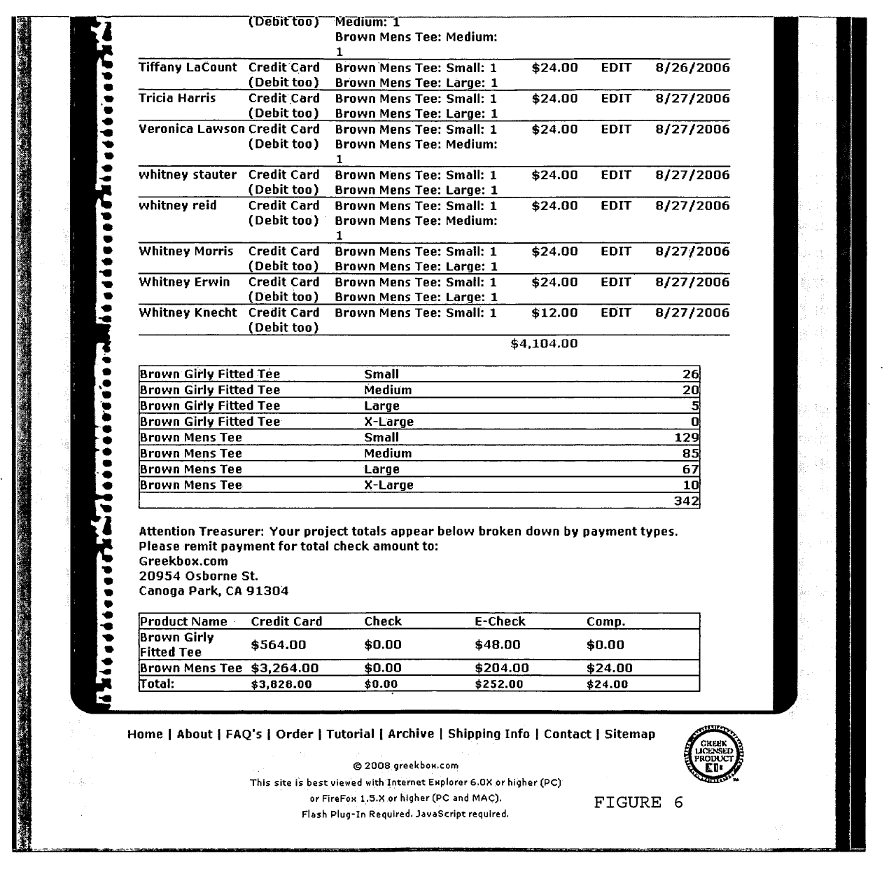

FIG. 6 comprises a screenshot of the second part of an order tracker report generated by one embodiment of the disclosure.

### DETAILED DESCRIPTION

This at least one method of facilitating online sales of a product to members of a group comprises at least one interactive computer software program electronically connected to the internet and adapted to electronically enable at least one step of any method disclosed. The enterprise may also comprise, in whole or in part, at least one person working with the software program in an enterprise to enable at least one step of any method disclosed.

This method is designed especially, but not exclusively, to provide creation for a commemorative product by a group chair working with an artist, to manufacture only the number of commemorative products actually purchased before manufacture by members of a group, and to ship the purchased products to the group members, care of the group chair, at the group's address. The method works well in the environment of a sorority or fraternity that wants to commemorate a social event, for example, the “Pi Beta Phi at Oklahoma 80's Event” with issuing T-shirts designed and sold only to Pi Beta Phi sorority members and their dates.

Each such product, such as a T-shirt or coffee mug, is designed by a group project administrator or “chair” working with the enterprise, together. Each product is uniquely designed collaboratively for its specific project.

The product's design is based on information provided to the enterprise by the chair via the internet. When the chair provides information to the enterprise, the enterprise ultimately generates a corresponding new project file that draws information from several databases. The new project file manages the project and sequesters sensitive information, providing it only on an “as needed” basis to the chair and the enterprise, as illustrated below.

The information provided by the client contact or chair comprises at least two general types, namely group identification information (“client profile”), and project specific information (“project profile”). For the purposes of this application, the term “client contact” is used interchangeably with the words “chair,” or “chairperson.”

In one embodiment of the disclosure, the chair enters both client profile and project profile information onto an “account information sheet,” [FIG. 1] which is a word processing generated “document,” and emails that completed document to the enterprise. A person at the enterprise receives the email from the chair, reads the email, and inputs the information so provided into the enterprise's client profile and project profile databases. In another embodiment of the disclosure, the chair enters client profile and project profile information into an FTP server. The software sorts the information entered accordingly. The enterprise then obtains the information so provided by transferring it therefrom onto the enterprise's computer and software system.

Once entered into its client profile database, client profile information may be may be used repeatedly by the enterprise each time a new project is done by the enterprise for that particular client. The enterprise can simply refer to the same information in that client's profile stored in the database comprising: chair name, name of the chair's organization, the position in the organization of the chair, chair's telephone numbers and email address(es), and other information that identifies the client itself or the chair for a given project. For a fraternity or sorority, the Greek letters of the chapter, along with the college or university and campus are also included in the client profile database.

The project profile information comprises information specific to creating a project-related product to be sold by the enterprise to group members by the enterprise after it is designed by a cooperative effort between the chair and enterprise, then manufactured by the enterprise. The chair provides project information to the enterprise comprising: color, style, approximate quantity, material, characteristics, and quality of the units onto which artwork will be printed, for example, blank T-shirts, coffee or beer mugs, paraphernalia, and mementos manufactured to commemorate a social event or college project.

The chair also provides artwork to the enterprise as project profile information. Such artwork information may be very generalized, such as naming a theme, for example “back to school,” or “the 1980's.” It may also be very specific, such as providing the enterprise with computer readable files that the enterprise may use directly in printing or manufacturing product for the group. Regardless of the degree of specificity, information provided by the chair concerning the physical appearance of the product being produced will be entered into the project profile.

Additionally, the date the order for product is placed, the date that the enterprise must provide product “in hands” to the group at its address, the date of the event planned by the group, and the mailing address of the group are all included as data in the project profile. This information is also provided to the enterprise by the chair.

After receiving data sufficient to create a product for the project, the enterprise employs a live artist to create artwork. The artist digitizes the artwork and provides it to the chair for approval or revisions until the chair approved the artwork. In one embodiment of the disclosure, exchanges of information between the artist and the chair concerning the artwork and revisions are done via email and the internet. In another embodiment of the disclosure, exchanges of information occur via an FTP server. The artist uploads digitized artwork onto the FTP site. When the artist had done so, according to the method of this embodiment, an email is sent by the FTP server to the chair's email address that artwork is ready for the chair's review. Simultaneously, a first signal is sent to the artist that the chair has not yet reviewed the artwork. When the chair has reviewed the artwork and submitted a reply, a second signal is generated by the FTP site to the artist. The artist receives the second signal, and thereby is informed that either approved artwork or edited artwork is awaiting the artist at the FTP site for retrieval.

Once artwork has been approved by the chair, the next phase of data management according to the method of the embodiment proceeds. The electronic file of the approved artwork is virtually “combined” with an image of the template, for example the T-shirt or mug, chosen by the chair. This creates an electronic image of the artwork superimposed on the template, or a virtual “product” as it would appear in reality. This virtual product image is combined with both client profile and project profile fields to create a project website and a unique hyperlink to that site. The chair is sent a confidential email by the enterprise comprising this hyperlink.

The project webpage comprises: name of the group's event, date of the event, cut-off date for ordering event product from enterprise, virtual product images and images of artwork; order selection fields such as size, color and quantity of product ordered; purchasing member information comprising name and email address; confidential member financial information comprising payment method choices, credit card identification information, sorority/fraternity billing information, or other billing information; and a “check out” feature to end the ordering transaction.

In one embodiment of the disclosure, each phase of creation of the artwork and webpage is manually recorded in a field in a database. In another embodiment of the disclosure, the software automatically updates a status field in a database to indicate which steps have been completed.

All data in the chair's client profile and project profile are fully accessible to the enterprise. The enterprise draws from both profiles and from them generates at least one product image and at least one project webpage, and positions any product image(s) on the at least project webpage. Each project is therefore associated with at least a unique webpage and at least one unique product. The at least one webpage also comprises at least one unique project hyperlink. After its generation from chair input information, the at least one webpage is quality-control reviewed by the enterprise. Upon enterprise approval, the at least one webpage is made available to the chair.

As indicated above, if and when the chair approves the artwork, a unique website is created and the enterprise then provides at least one unique hyperlink to that site to the chair. FIG. 3. Usually this is done by the enterprise sending an email message containing at least a unique hyperlink to the chair. The chair is then also instructed in that email by the enterprise to make the webpage available only to group members through the unique hyperlink, for example, by sending the link to members by email. Alternatively, the chair may make the link available to members on a password protected group web page.

The at least one project webpage, which comprises at least a virtual image of the product as created by superimposing artwork on a blank template product [FIG. 3, left margin], is adapted to electronically collect and store information input by members. Members are themselves able to input member identification information, product ordering information, and payment information. FIG. 4. Once the enterprise has confirmed that the member's payment information is valid and that the member is entitled to purchase product as ordered, the member's order for product is generated by the enterprise, and the product is manufactured by the enterprise and sent to the member. A receipt is generated by the enterprise and made electronically available to each member who orders a product. In one embodiment of the disclosure, the product is manufactured in-house by the enterprise.

The method of the disclosure is uniquely, but not exclusively, adapted to ensure privacy to young women living in a sorority house who want to order paraphernalia for a social event. It is important that a complete list of all women living at a single location be kept as secure as possible. Limited access to such a full list is therefore desired. The embodiment of the disclosure provides only the names and email addresses of the women who place product orders to the enterprise. Therefore, the enterprise has only limited access to group member personal information.

Along the same vein, the project chair in a sorority house is typically a sorority sister and should not have access to the personal financial information/credit card numbers of her sorority sisters. This extends to other groups and their chairs, in that the chair of an event is typically a member who volunteers to organize a social event, and is not bonded or financially guaranteed by the group. Therefore, the chair may not have access to the private financial information of the group members. However, the chair may also be charged with monitoring product sales and ensuring such sales stay within limits through an “Order Tracker,” such as that providing at FIGS. 5 and 6. Monitoring and sales editing are therefore necessary or desirable features of the disclosure. The method of the embodiment provides the chair with a limited ability to monitor and edit her sisters' product orders while keeping their credit card numbers confidential.

According to a method of the disclosure, a second hyperlink may also sent be sent to the chair by the enterprise. This is a hyperlink to an unpopulated database resident in the enterprise's computer. This database is populated only when group members order product from the enterprise. The database not populated with any confidential financial information belonging to any group member. The chair is enabled by a method of the disclosure, through the hyperlink, to edit or to change the group member's order without being able to see or read personal financial information.

Even outside of a sorority setting a chair and enterprise may agree that the chair should have limited access to member ordering information and that the chair may change one or more aspects of members' orders. In at least one embodiment of this disclosure, the enterprise creates a second hyperlink sent by email only to the group's chair. It provides access to each member's ordering information. The chair is able to monitor and edit each member's product order after each member places a product order.

A further embodiment discloses computer software created to effect the steps comprising: creating a custom web page for providing limited access to members of a group from information provided by a representative group member; creating a product representation on the webpage based on information provided by a representative group member; providing access to the custom web page members; collecting and confirming product ordering information from members; effecting the manufacture and shipping of product ordered by a member to that member; providing access to member information; enabling manipulation of member information to provide order tracking reports, production reports and other financial reports concerning productivity and profit.

A still further embodiment of the method of the disclosure comprises defining and identifying a group comprising group members and identifying at least one contact person in the group. The enterprise collects identifying and contact information about the group generally from the at least one contact person, and stores the information, for example, at an FTP site. From this stored information, a client record is created.

The method of the disclosure also enables the enterprise to collect at least one design concept for creation of paraphernalia from the at least one contact person who edits the design, loading the edited design onto the FTP site as a project file. Software at the FTP site then signals the contact to check the edited design via an email message. During the time that the enterprise is awaiting the contact's design feedback, the FTP sends a first signal to the enterprise. When the contact responds concerning the design, a second signal is sent to the enterprise, signaling that the enterprise should visit the FTP site and view the design file.

After approval of the design by the contact person, the method of the disclosure enables the enterprise to create at least one new webpage by using both group identification and address information and design input for paraphernalia collected from a contact person. This at least one new webpage comprises its own special link specifically and exclusively for members of the contact person's group. This link is forwarded to the at least one contact person by the enterprise. Digital images on the at least one webpage of the at least one paraphernalia design are provided to the contact person at least one member ordering paraphernalia from the webpage.

The enterprise collects paraphernalia order information from each ordering member, comprising size, color, design preference, and payment information. The enterprise does not collect member information from non-ordering members. Upon confirmation of payment information, the ordered paraphernalia is shipped to all members care of the at least one contact person.

A method of facilitating online design and sales of a product of the disclosure also comprises designing at least one unique product for a group's social event by receiving artistic and thematic input, and editing that input. A member interactive product ordering webpage, comprising one or more images of the designed product, coupled with interactive data fields adapted to receive product selection data from a group member, is created. This webpage is designed to transmit said data to the enterprise.

This webpage according to the method of the enabling disclosure is also designed to receive product purchasing data, including financial data such as credit card information sufficient to enable the enterprise to complete a sale and to create an invoice for the group member, from any ordering group member and transmit said data to the enterprise. The enterprise also provides information about which group members have ordered product to the group representative. However, the group representative is not given financial data, such as credit card information sufficient to enable the group representative to make a purchase using the group member's credit card.

According to the method of the disclosure, interactive data fields are adapted to enable the group representative monitor and edit group member product selection data. The enterprise records a list of the names of the group members that order products for a given project, the group representative, and the single common geographic address of all members of the group to which all product ordered by group members will be shipped.

Another enabling method of the disclosure comprises: obtaining identification data concerning a group and group members with a single physical address from at least one contact person; obtaining the single physical address for product shipment from the at least one contact person; obtaining at least one design concept for use in designing products from the at least one contact person; creating at least one product from the design concept; providing an image of the at least one product to the at least one contact person for approval via the Internet; receiving design feedback from the at least one contact, modifying the design as required and receiving approval for the at least one design from the at least one contact; creating a limited access webpage therefrom; enabling members to order product through at least a first webpage; enabling the at least one contact person to monitor and edit group member's product ordering; enabling the enterprise fulfilling product orders to issue product purchase invoices therefrom; correlating the single address of the group, the members' orders, and the contact person's edits, and creating a set of products corresponding thereto packaged to be sent to a single address; and sending the set of products to the group members at the single address.

What is claimed is:

1. A method comprising collecting, processing, storing and managing digitized information to create and sell product commemorating an event to a group comprising:
a. defining and identifying a group comprising group members;
b. identifying at least one contact person in the group;
c. collecting and storing group contact and address information from the at least one contact person in a client profile database;
d. collecting and storing at least one design concept for artwork from the at least one contact person in a project database;
e. creating artwork from the design concept, digitizing the artwork, and storing it in a project database, and providing the digitized artwork to the contact person for review;
f. receiving the contact person's comments concerning the artwork and storing same in the project database;
g. editing the artwork according to the contact person's comments and saving the edited artwork in the project database;
h. obtaining artwork approval from the contact person and storing the approval in a project database;
i. collecting and storing project template information from the at least one contact person in the project database;
j. creating at least one virtual image of a product from the approved artwork and the template information and storing that at least one virtual image;
k. creating at least one unique webpage from the virtual image, information from the client profile and the project profile to create a project webpage and a hyperlink;
l. providing that hyperlink to the least one contact person;
m. providing the hyperlink to at least one member through the contact person for the purpose of ordering product from the webpage;
n. collecting confidential financial information and non-confidential member information from an ordering member;
o. providing all information provided by ordering member to the enterprise;
p. creating an unpopulated member ordering database resident at the enterprise and sending a hyperlink to that database to the contact person;
q. populating the member ordering database with non-confidential member information when the member orders product;
r. enabling the contact person to edit the member's product order;
s. directing production of the product ordered by the ordering member, as edited by the contact person, upon confirmation of the member's payment information; and
t. shipping produced product to the at least one contact person.

2. A method of facilitating online design and sales of a product for a client comprising:
a. building a client file comprising data fields comprising at least a client's name, position, email address, group, group address and financial information;
b. building a client project file comprising data fields comprising at least a client's event title, event date, in hands date, mailing address, product template information and art design information;
c. receiving information from a client for data fields in the client file and inputting same;
d. receiving information from a client for the project file and inputting same;
e. building a client interactive product order webpage from the inputted client file and project file data comprising at least one or more images of a designed product coupled with interactive data fields adapted to receive product selection data from the client's group member and transmit said data to an enterprise;
f. building an internal database comprising a list of the names of the client's group members that ordered products, the client, and the group address to which all product ordered by group members will be shipped;
g. providing a pair of hyperlinks to the client by email, wherein one hyperlink is linked to the client interactive product order webpage and the second hyperlink is linked to an unpopulated database filled when members order product and made available through this hyperlink onto to the client;
h. instructing the client to forward only the first hyperlink to the group members; instructing the client to monitor the group member's product selection and edit same through the second hyperlink;
i. receiving product selection data and product purchasing data via the Internet through the interactive data fields of the group member webpage;
j. creating the unique products according to the orders placed by group members and client through the group member webpage; and
k. shipping the unique products to the group members and client at the common geographic location.

3. An enterprise's method of obtaining and processing data for facilitating online sales and product via the Internet comprising:
a. obtaining identification data concerning a group and group members with a single physical address from at least one contact person;
b. obtaining the single physical address for product shipment from the at least one contact person;
c. obtaining at least one design concept for use in designing products from the at least one contact person;
d. creating at least one product from the design concept;
e. providing an image of the at least one product to the at least one contact person for approval via the Internet;
f. receiving design feedback from the at least one contact, modifying the design as required and receiving approval for the at least one design from the at least one contact;
g. enabling members to order product through at least a first webpage;
h. enabling the at least one contact person to monitor and edit group member's product ordering;
i. correlating the single address of the group, the members' orders, and the contact person's edits, and creating a set of products corresponding thereto packaged to be sent to a single address; and
j. sending the set of products to the group members at the single address.
